(19) United States
(12) Patent Application Publication
(10) Pub. No.: US 2015/0320524 A1
(43) Pub. Date: Nov. 12, 2015

(54) CNC MACHINE CALIBRATION

(71) Applicant: Custom Automated Prosthetics, LLC, Stoneham, MA (US)

(72) Inventor: Matthew T. Stratton, Woburn, MA (US)

(21) Appl. No.: 14/705,114

(22) Filed: May 6, 2015

Related U.S. Application Data
(60) Provisional application No. 61/989,265, filed on May 6, 2014.
(60) Provisional application No. 61/989,309, filed on May 6, 2014.

(51) Int. Cl. A61C 13/00; G05B 19/4097

(52) U.S. Cl. CPC A61C 13/0004; G05B 19/4097; G05B 2219/45167; G05B 2219/45145; G05B 2219/33099

(57) ABSTRACT

A method for calibrating a computer numerical control (CNC) machine for milling an implant abutment includes creating a calibration part by milling reference surfaces with predetermined coordinates into a blank stock held by a CNC fixture. By measuring the milled reference surfaces of the calibration part and comparing the measurements to the predetermined coordinates, the CNC fixture can be accurately placed in a global coordinate system, thereby allowing for the derivation of shifts in an abutment geometry in each of the x, y, and z axes in order to align a fabricated abutment relative to the CNC fixture. The shifts may then be used to adjust a control of the CNC machine to match a present state of the CNC machine and the CNC fixture.

### CROSS-REFERENCE TO RELATED APPLICATIONS

This application claims the benefit of U.S. Prov. App. No. 61/989,265 filed on May 6, 2014, and U.S. Prov. App. No. 61/989,309 filed on May 6, 2014, where the entire contents of each is hereby incorporated by reference.

### TECHNICAL FIELD

The disclosure relates to computer numerical control (CNC) machine calibration, and more specifically to CNC machine calibration for the fabrication of dental implant abutments.

### BACKGROUND

In the field of dentistry, implant abutments may be used with dental implants in a patient. The implant abutments may include two interfaces—a first interface for cooperation with the dental implant, and a second interface for cooperation with the anatomy of the patient (e.g., a patient's gum tissue, bone, etc.). Often, implant abutments are formed out of “blanks” that have the proper geometry of the first interface pre-formed thereon—e.g., the first interface may be standard for the type of dental implant or the manufacturer of the dental implant to be used with the abutment. The second interface may then be milled or otherwise fabricated from the blank with the pre-formed first interface to create the implant abutment with both interfaces. Often, a computer numerical control (CNC) machine is used for the milling of the second interface onto the blank, where the blank is held by a CNC fixture during milling. When a CNC machine is used, there may exist a variability in how the CNC fixture is secured into the CNC machine, how the blank is positioned in the CNC fixture, and/or how the blank is positioned within the CNC machine (e.g., relative to the tooling used by the machine). Because the blank may include a pre-formed geometry of the first interface, the blank should be milled such that the first and second interfaces have a proper alignment. Thus, calibration of the CNC machine for milling implant abutments is desirable.

There remains a need for improved calibration techniques for use with milled parts.

### SUMMARY

A method for calibrating a computer numerical control (CNC) machine for milling an implant abutment includes creating a calibration part by milling reference surfaces with predetermined coordinates into a blank stock held by a CNC fixture. By measuring the milled reference surfaces of the calibration part and comparing the measurements to the predetermined coordinates, the CNC fixture can be accurately placed in a global coordinate system, thereby allowing for the derivation of shifts in an abutment geometry in each of the x, y, and z axes in order to align a fabricated abutment relative to the CNC fixture. The shifts may then be used to adjust a control of the CNC machine to match a present state of the CNC machine and the CNC fixture.

### BRIEF DESCRIPTION OF THE FIGURES

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 is a side view of an abutment design.

FIG. 2 is a bottom/side perspective view of a blank stock with a pre-formed implant interface.

FIG. 3 is a side view of a milled abutment.

FIG. 4 shows an example of a CNC fixture.

FIG. 5 shows an example of a CNC fixture with a blank stock.

FIG. 6 shows an example of a CNC fixture with a milled abutment.

FIG. 7 is a flow chart of a method for CNC calibration.

FIG. 8 is a front perspective view of a calibration part.

FIG. 9 is a side perspective view of a calibration part.

FIG. 10 is a side perspective view of a calibration blank.

FIG. 11 is a flowchart showing a method for calibrating a CNC machine.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose, or where applicable, any acceptable range of deviation appropriate to a measurement of the numerical value or achievable by instrumentation used to measure the amount. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “above,” “below,” and the like, are words of convenience and are not to be construed as limiting terms.

The following description emphasizes computer numerical control (CNC) machine calibration for the fabrication of implant abutments in the field of dentistry. It will be understood, however, that the devices, systems, and methods described herein may be adapted for the calibration of other machines fabricating other objects.

While the following description emphasizes CNC machines, it will be appreciated that the techniques described herein may be suitably adapted to any devices, systems, and methods for rapid fabrication of three-dimensional objects, particularly techniques using subtractive processes to reductively fabricate parts from mill blanks or other bulk material(s), and the term CNC machine should be understood to include all such similar methods, systems, and devices. The machine tools of a CNC machine may be operated by programmed commands encoded on a storage medium that, when executed by the CNC machine, causes the machine tools to fabricate a three-dimensional object from a mill blank or other starting material. The CNC machine may include an end-to-end component design system that is highly automated using, e.g., computer-aided design (CAD) and computer-aided manufacturing (CAM) programs to create three-dimensional models that can in turn be used to generate commands to control the machine tools of the CNC machine.

In general, an “implant abutment” or simply “abutment” (or the like) may be used in dentistry in cooperation with a dental implant, i.e., where the dental implant retains the implant abutment. This abutment generally has two physical interfaces—a first interface for cooperation with the dental implant itself, and a second interface for cooperation with the anatomy of the patient (e.g., a patient's gum tissue, jaw bone, etc.). Each of these interfaces may include specific geometries, i.e., the first interface having a specific geometry to match that of the dental implant's interface, and the second interface having a specific geometry to match that of the patient's anatomy. The configuration of the geometry of the first interface relative to the geometry of the second interface may require precision in order for the abutment to function properly.

Often, implant abutments are formed out of “blanks” that have the proper geometry of the first interface pre-formed thereon—e.g., the first interface may be standard for the type of dental implant or the manufacturer of the dental implant to be used with the abutment. The second interface may then be milled or otherwise fabricated from the blank with the pre-formed geometry of the first interface to create the implant abutment with both interfaces.

For example, during fabrication, a portion of the abutment may be secured in a CNC fixture (e.g., a fixture that is placed within the CNC machine and that holds an object being fabricated) while the second interface of the abutment is milled. This may require a precise fit of the abutment into the CNC fixture so that features on the first interface and the milled portion of the abutment (i.e., the second interface) are properly spatially matched to features within the CNC fixture. In order to facilitate this alignment, a blank may be placed into the CNC fixture and milled with a number of test features. By measuring the resulting milled piece, an alignment of the CNC fixture and the milling tool(s) of the CNC machine can be precisely determined and used to properly locate a model of the abutment relative to the CNC fixture during fabrication of the actual abutment.

Described herein are devices, systems, and methods for calibrating a CNC machine, and more specifically, calibrating a CNC machine for the fabrication of an abutment with a pre-formed implant interface for a dental implant.

The “dental implants” may include any portion of implants that may be used for restorative dentistry or the like, which may be generally understood to include components that restore the structure or function of existing dentition, such as crowns, bridges, veneers, inlays, onlays, amalgams, composites, and various substructures such as copings and the like, as well as temporary restorations for use while a permanent restoration is being fabricated. The dental implants may include endosseous, subperiosteal, and transosteal implants. The dental implants may also or instead include a prosthesis that replaces dentition with removable or permanent structures, such as dentures, partial dentures, implants, retained dentures, and the like. The dental implants may also or instead include appliances used to correct, align, or otherwise temporarily or permanently adjust dentition, such as removable orthodontic appliances, surgical stents, bruxism appliances, snore guards, indirect bracket placement appliances, and the like. The dental implants may also or instead include hardware affixed to dentition for an extended period, such as implant fixtures, orthodontic brackets, and other orthodontic components. The dental implants may also or instead include interim components of dental manufacture such as dental models (full and/or partial), wax-ups, investment molds, and the like, as well as trays, bases, dies, and other components employed in the fabrication of restorations, prostheses, and the like. Dental implants may be categorized as natural dental objects such as the teeth, bone, and other intraoral structures or as artificial dental objects such as the restorations, prostheses, appliances, hardware, and interim components of dental manufacture.

The abutment or implant abutment as described herein may be any structure that engages with the dental implant as described herein, or is part of the dental implant described herein. For example, the abutment may be a connecting element including a structure (implant interface) that connects to a dental implant having a screw-like component or the like. The abutment may also include an abutment geometry for engaging with, e.g., a bridge or a crown. The abutment may be made from a variety of materials, such as titanium, surgical stainless steel, gold, ceramic (e.g., zirconia), and so forth. The abutment may be connected to the dental implants via a screw, which is tightened to avoid loosening during chewing, or by other means known in the art.

The devices, systems, methods, and techniques described herein may be better understood through a description an abutment and a CNC fixture, which follows.

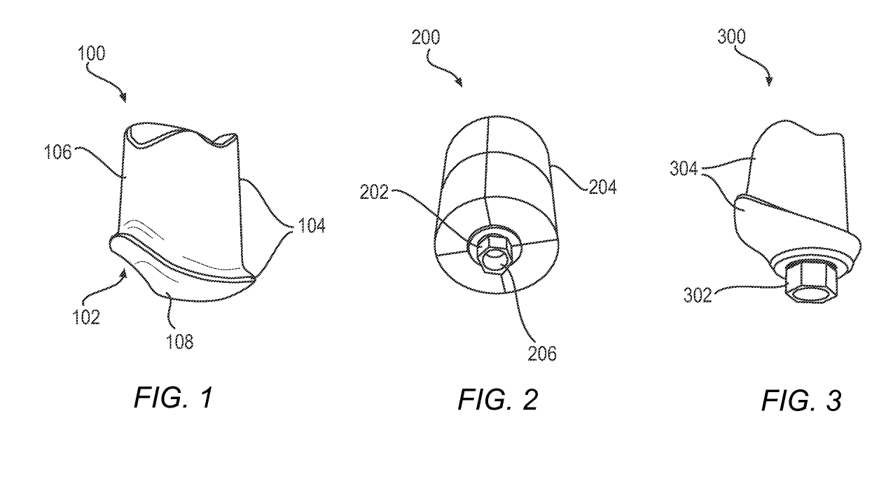

FIG. 1 is a side view of an abutment design. Specifically, the figure shows a computer-aided design (CAD) model 100 of an abutment 102. The CAD model 100 may be configured particularly for a specific patient, e.g., to engage with the anatomy of the patient, or a particular dental implant. Thus, the abutment 102 included within the CAD model 100 may be designed with an abutment geometry that is specific to the particular patient or the particular dental implant. The abutment 102 may include a plurality of interfaces, e.g., a first interface (not shown) and a second interface 104, where the first interface is configured for engagement with a dental implant and the second interface 104 is configured for engagement with the anatomy of the patient. For example, the design of the second interface 104 may include a first end 106 and a second end 108, where the first end 106 is designed to be disposed beneath a patient's gumline and the second end 108 is designed to be disposed above a patient's gumline.

FIG. 2 is a bottom/side perspective view of a blank stock with a pre-formed implant interface. Specifically, the figure shows a pre-formed blank stock 200 with a specific implant interface, i.e., the first interface 202, and a milling portion 204 that can be milled to provide a second interface for engagement with the anatomy of a patient.

The pre-formed blank stock 200 may include a substantially cylindrical-shaped stock that forms the milling portion 204, or other area to be milled to form the second interface for engagement with the anatomy of a patient. The blank stock 200 may instead include other shapes, such as being substantially block-shaped or the like. The blank stock 200 may be provided with a manufacturer implant interface included thereon that forms the first interface 202.

The first interface 202 may thus include a manufacturer implant interface, which can come in different shapes and sizes. For example, the first interface 202 may include a substantially hexagonal shape as shown in the figure. The first interface 202 may instead include alternate shapes, such as other polygons, tetrahedrons, rounded structures, or any other structure or combination of structures and features suitable for securely retaining the blank stock 200 securely and in a predetermined orientation during a milling procedure. As stated above, the first interface 202 may be standard for the type of dental implant or the manufacturer of the dental implant to be used with the abutment that will be formed from the blank stock 200.

The first interface 202 may include a void 206 or other engagement area/volume for accepting a screw, pin, projection, or the like, included on the dental implant. The void 206 may further include any associated threading or the like to accommodate engagement with the dental implant. Alternatively, the void 206 may be replaced or supplemented with a projection such as a screw, pin, or the like, for engagement with a corresponding void on the dental implant.

The pre-formed blank stock 200 may be fixtured into a CNC machine, e.g., using a CNC fixture of the CNC machine. The CNC fixture may secure the pre-formed blank stock 200 within the CNC machine during a milling process, such as a milling process that forms the second interface for engagement with the anatomy of a patient.

FIG. 3 is a side view of a milled abutment. The milled abutment 300 may be the result of milling the design of an implant abutment (e.g., the CAD model of FIG. 1) into a blank stock (e.g., the pre-formed blank stock of FIG. 2). Thus, the milled abutment 300 may include a first interface 302 and a second interface 304, where the first interface 302 is the implant interface and the second interface 304 is the interface designed/milled for engagement with the anatomy of the patient (i.e., the abutment geometry). The milled implant abutment may be created by the CNC machine, which mills out the abutment geometry and preferably in the correct position relative to the implant interface.

The first interface 302 may be a pre-formed implant interface. In an alternate embodiment, the first interface 302 is also milled by a CNC machine or the like.

The second interface 304 may be aligned with the first interface 302 such that the dental implant can be aligned and configured in the proper, intended manner within a patient's dentition. The figure therefore may represent a desired abutment geometry aligned with the implant interface. In order for the interfaces to be aligned, the pre-formed blank stock (from which the milled abutment 300 is formed) should be placed within a CNC machine in a proper manner, and/or the CNC machine should be calibrated for the placement of the pre-formed blank stock. The process for forming the milled abutment 300 shown in the figure may be optimized through the CNC machine calibration techniques described herein.

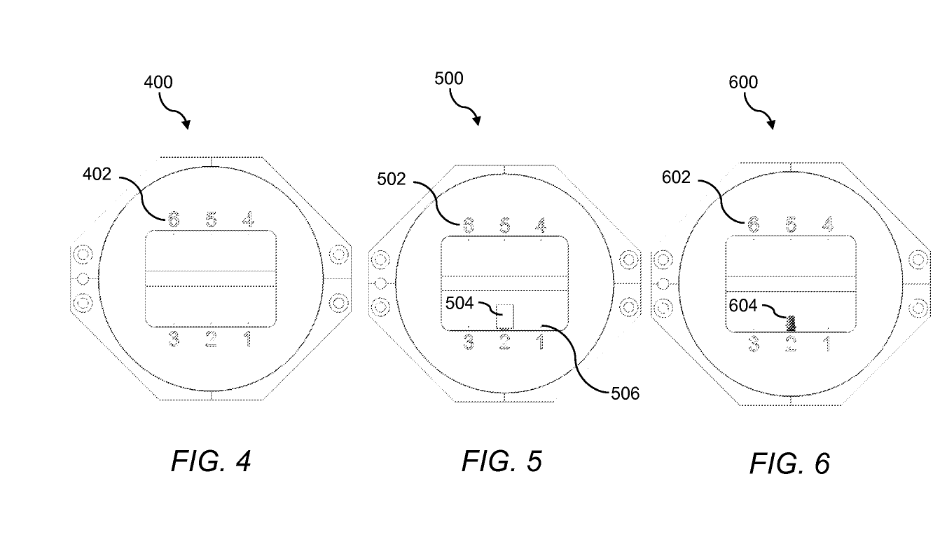

A CNC fixture will now be discussed. FIGS. 4-6 show an example of a CNC fixture that can hold up to six blank stocks at one time. One skilled in the art will recognize that the CNC fixture shown in the figures is provided by way of example only, and that the devices, systems, methods, and techniques described herein may be used with other CNC fixtures. For example, CNC fixtures having different shapes and sizes, or CNC fixtures holding more or less blank stocks may be used.

FIG. 4 shows an example of a CNC fixture. Specifically, the figure shows an empty CNC fixture 400, i.e., where there are no blank stocks included within the CNC fixture 400. As discussed above, the CNC fixture 400 shown in the figure may be capable of holding up to six blank stocks at one time, where the CNC fixture 400 includes stations 402 for holding the blank stocks.

FIG. 5 shows an example of a CNC fixture with a blank stock. As shown in the figure, the CNC fixture 500 may secure the blank stock 504 in one of its stations 502 for holding blank stocks (specifically, the blank stock 504 may be disposed in station number two as shown in the figure).

The blank stock 504 may be any as discussed herein, and may include a pre-formed first interface, e.g., a manufacturer implant interface, and a substantially cylindrical-shaped stock for milling a second interface for engagement with the anatomy of a patient.

One or more of the stations 502 may include a securing element 506 or series of elements for holding the blank stock 504 within the CNC fixture 500. The securing element 506 may include a projection such as a screw or the like that engages with the pre-formed first interface. The securing element 506 may also or instead include a clamp or the like that engages with the pre-formed first interface or other portion of the blank stock 504. The securing element 506 may also or instead include a void or slot. Other securing elements 506 are also or instead possible.

FIG. 6 shows an example of a CNC fixture with a milled abutment. Thus, this figure may represent the CNC fixture 600 after a blank stock is milled in a station 602 thereon by a CNC machine or the like to form a milled abutment 604 (i.e., a milled implant abutment). In other words, in the implementation shown, a CNC machine has milled out the specific geometry of the second interface (i.e., the abutment geometry) from the blank stock such that it is properly aligned with the first interface and/or the CNC fixture 600.

The figures above may represent an end user workflow of forming an implant abutment from a blank stock. Without the calibration techniques described herein, the end-user workflow described above may be problematic in that there can be variability in how the CNC fixture gets secured into the CNC machine. For example, in an aspect where the CNC machine does not have a probe, the CNC machine does not know exactly where the blank stock is positioned within the CNC machine. Also, if the blank stock contains a pre-formed geometry of the implant interface (i.e., the first interface), the CNC machine should mill the blank stock in a preferred position such that the abutment geometry, i.e., the three-dimensional shape of the abutment or portions thereof, matches the implant interface (i.e., the second, milled interface is in the correct position relative to the first, pre-formed interface).

The devices, systems, and methods described herein may alleviate problems associated with the end-user workflow described above by calibrating the computer-aided manufacturing (CAM) set up for each CNC machine and CNC fixture. In one aspect, by periodically machining a calibration part as described herein, the abutment geometry may be positioned in the CAM set up such that it matches the current state of the CNC machine and the CNC fixture. This calibration process may involve milling reference surfaces into a blank stock that can be measured relative to the unmilled areas of the blank stock as described herein.

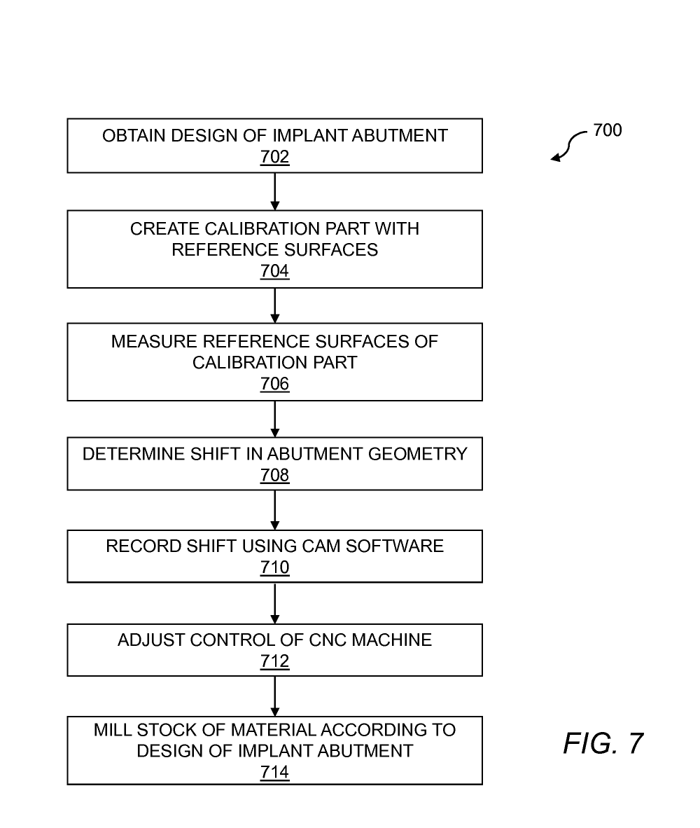

FIG. 7 is a flowchart showing a method for calibrating a CNC machine. The CNC machine may be any as described herein or otherwise known in the art. The calibration for a CNC machine may be advantageous for the formation of an implant abutment from a blank stock having a dental implant interface pre-formed thereon (otherwise referred to herein as an implant interface or the first interface). Specifically, the implant abutment may be formed through milling the blank stock such that it has a specific abutment geometry on an interface thereof (i.e., the second interface) for engagement with the anatomy of the patient.

As discussed above, the CNC machine may be a machine for milling an item, e.g., an implant abutment for a dental implant. Although this document references an implant abutment, a skilled artisan will recognize that the devices, systems, and methods described herein may be adapted for the production of other items/parts/components using a CNC machine. Additionally, although this document references a CNC machine include a milling machine, a skilled artisan will recognize that the CNC machine may also or instead include a lathe, plasma cutter, electric discharge machine, water jet cutter, drill, router, hot wire cutter, grinder, and so forth.

As shown in step 702, the method 700 may include obtaining a design of an implant abutment. The implant abutment may include an abutment geometry, where the abutment geometry includes the general shape of the implant abutment and the design of the outer surfaces of the implant abutment. The abutment geometry may be sized and shaped to engage with a patient's anatomy (e.g., a patient's gum tissue, bone, etc.) as well as with a dental implant, e.g., a bridge or crown. Thus, in an aspect, the abutment geometry is customized for a specific patient's anatomy.

The implant abutment may have an implant interface (i.e., the first interface discussed above), which is the interface at which the abutment and the implant engage one another. In other words, the implant interface may be designed to engage with a corresponding interface disposed on the dental implant. The dental implant may have a specific interface/connection area depending upon, for example, the type of dental implant or the manufacturer of the dental implant. The specific interface/connection area on the dental implant may have a specific geometry (e.g., size and shape). The implant interface may thus include a specific geometry to engage with the interface on the dental implant. For example, the implant interface may include, without limitation, a substantially hexagonal shape (or other polygonal shape), a substantially cylindrical shape, a substantially conical shape, and so on. The implant interface may be part of the overall abutment geometry, or it may be separate from the abutment geometry. In the implant abutment, the alignment of the abutment geometry or portion thereof with the implant interface may affect the function, look, feel, and effectiveness of the dental implant. In particular, the abutment geometry (i.e., the second interface, where the abutment engages with the anatomy of a patient) may need to be properly aligned with the implant interface to function properly with the dental implant and the patient's anatomy.

The design of the implant abutment may be created by a dentist, a medical doctor, or the like. The design may be received by a system to calibrate a CNC machine, a CAD or CAM program, or similar. The design may be a generic or universal design, or it may be a specific design that is custom for a particular patient, or any combination thereof. In one aspect, the design of the implant abutment includes a customized abutment geometry (i.e., second interface) cooperating with a generic implant interface (i.e., first interface) based on, e.g., the type of dental implant or the manufacturer of the dental implant. The design may be created using any known techniques, including, without limitation, through three-dimensional scanning and using three-dimensional digital data with a CAD program.

As shown in step 704, the method 700 may include creating a calibration part for the CNC machine, where the calibration part includes reference surfaces. Specifically, creating the calibration part may be accomplished through milling a plurality of reference surfaces into a blank stock held by a CNC fixture.

The calibration part may be created from a blank stock of material. The blank stock of material used to create the calibration part may or may not include a pre-formed component, e.g., a pre-formed implant interface or an interface for engagement with the CNC fixture. The blank stock of material used to create the calibration part may also or instead include a stock that is manufactured specifically for calibration.

The calibration part may be utilized to calibrate the CNC machine as described herein. The calibration of the CNC machine may include a calibration of the CNC machine itself and tooling therein as well as the specific CNC fixture used to hold the blank stock that will become the calibration part (i.e., after the reference surfaces are milled). This calibration may be advantageous for the creation of implant abutments with pre-formed implant interfaces, where the design of the abutment geometry relative to the pre-formed implant interface affects the function, look, feel, and effectiveness of the dental implant when the dental implant is engaged with the implant abutment.

The plurality of reference surfaces may include surfaces corresponding to each of an x, y, and z axis, such as surfaces or pairs of surfaces normal to each of the x-axis, the y-axis, and the z-axis, or any other surface or combination of surfaces adapted to receive or facilitate a measurement of location along the relevant access, and more particularly a measurement referenced to a global coordinate system. The reference surfaces may be designed and tooled from predetermined coordinates, where instructions for the milling of these reference surfaces are provided to the CNC machine based on the predetermined coordinates. The milling process may leave unmilled areas of the calibration part while creating the reference surfaces.

The predetermined coordinates may be determined relative to unmilled areas of the calibration part. The predetermined coordinates may also or instead be determined relative to one or more of the CNC fixture, the CNC machine, the implant interface on the calibration part, or another set of coordinates or coordinate system.

The CNC fixture may any as described herein or otherwise known in the art. For example, the CNC fixture may be a component that is used to position and hold the stock during the manufacturing of the implant abutment and during the creation of the calibration part. Thus, the CNC fixture may hold a blank stock with a pre-formed implant interface. The CNC fixture may include, without limitation, a fixture plate (which may also be referred to as a tooling plate), a clamp, a hold down, a tombstone, a grid plate, a vise, and so forth. In one aspect, the CNC fixture is customized for the creation of implant abutments. The CNC fixture may engage with the CNC machine, where it is secured within the CNC machine to hold the blank stock. There may be some variability in the engagement of the CNC fixture within the CNC machine, which may affect the milling of the blank stock, e.g., when the CNC fixture is removed and replaced within the CNC machine. For example, the variability may be 0.5 mm or greater, which may include a shift in at least one of the x, y, and z axes, or a rotation. This variability can greatly affect the implant abutment and the dental implant if not accounted for, e.g., because of the shift in the abutment geometry relative to the implant interface geometry. For example, the variability may be so large that the CNC machine may mistakenly mill the pre-formed implant interface (i.e., the first interface) instead of the milling portion (i.e., the second interface), thus rendering the implant abutment clinically unacceptable. The techniques discussed herein can be adjusted to account for this variability.

As shown in step 706, the method 700 may include measuring the plurality of reference surfaces of the calibration part. The reference surfaces may be measured relative to the unmilled areas of the calibration part. Additionally or alternatively, the reference surfaces may be measured relative to a coordinate system, which may be the same coordinate system used for the predetermined coordinates provided to the CNC machine for the creation of the calibration part. Measuring of the reference surfaces milled into the calibration part may be relative to an ideal location of the reference surfaces, where the ideal location of the reference surfaces is known relative to unmilled surfaces of the calibration part. Thus, measuring the actual milled reference surfaces relative to the unmilled surfaces in each of the x, y, and z axes may yield a shift that can be used to adjust the CNC machine (or a component thereof) in order to create an ideal implant abutment.

As shown in step 708, the method 700 may include determining a shift in the abutment geometry. The shift in the abutment geometry may be determined in each of the x, y, and z axes using measurements obtained from the calibration part. For example, the shift in the abutment geometry may be determined through a comparison of measurements obtained from the calibration part to the predetermined coordinates used to create the reference surfaces. In this manner, the difference (i.e., the shift) between the actual coordinates of the reference surfaces and the predetermined coordinates may be ascertained. This may allow for the CNC fixture to be placed in a global coordinate system in order to align an abutment to the CNC fixture. Thus, steps may be taken to account for this shift when creating the implant abutment such that the abutment geometry and the implant interface are properly aligned. The shift in the abutment geometry may also or instead be determined from a comparison of the expected measurements of the reference surfaces of the calibration part (based on instructions provided to the CNC machine when creating the calibration part) to the actual measurements of the reference surfaces of the calibration part as measured in the step recited above. In an aspect, the shift in the abutment geometry is relative to the implant interface. In another aspect, the shift in the abutment geometry is relative to the CNC fixture or its position within the CNC machine. The shift in the abutment geometry may also or instead include an angular shift or a rotation.

As shown in step 710, the method 700 may include recording the shift using CAM software. Recording the shift using CAM software may be advantageous so that the system knows the shift for a particular CNC fixture, machine, abutment, and so on. Specifically, in an aspect, the determined shift is fed back into CAM software so that future jobs will have a calibrated, corrected alignment of the abutment geometry relative to the CNC fixture, and to the implant interface retained in the CNC fixture. The CNC machine (or tooling thereof) may then translate and/or rotate to account for the shift. In one aspect, subsequent blank stocks are offset in each of the x, y, and z axes based on the determined shift.

As shown in step 712, the method 700 may include adjusting a control of the CNC machine. For example, the control may be adjusted according to the shift in the abutment geometry to match a present state of the CNC machine and the CNC fixture. The present state of the CNC machine and the CNC fixture may include the CNC machine with the specific CNC fixture included therein. In this manner, if the measurements of the reference surfaces of the calibration part do not match the predetermined coordinates (or the expected measurements of the reference surfaces of the calibration part based on instructions provided to the CNC machine when creating the calibration part), the present state of the CNC machine and the CNC fixture may include a state where the CNC fixture, the CNC machine (e.g., the CNC tooling), the blank stock, or the design of the implant abutment can be adjusted in order to properly align the abutment geometry and the implant interface when the implant abutment is created. Thus, in one aspect, the techniques described herein are configured to allow the CNC machine to accurately mill the blank stock in order to fabricate the implant abutment based on the position of the CNC fixture and the blank stock within the CNC machine. Adjusting the control of the CNC machine may also or instead include adjusting a setup of a CAM system.

Adjusting the control of the CNC machine may also or instead include adjusting the abutment geometry to be milled into the blank stock. Alternatively, adjusting the abutment geometry to be milled into the blank stock may replace the step of adjusting the control of the CNC machine. Adjusting the control of the CNC machine may also or instead include offsetting blank stocks in each of the x, y, and z axes based on the determined shift. Alternatively, offsetting blank stocks in each of the x, y, and z axes based on the determined shift may replace the step of adjusting the control of the CNC machine.

As shown in step 714, the method 700 may include milling a stock of material according to the design of the implant abutment using the calibrated CNC machine.

In general, the devices, systems, and methods described herein may include calibrating a CNC machine to accurately mill implant abutments from a pre-formed stock that has the implant interface pre-machined therein. The devices, systems, and methods described herein may be useful for CNC machines that do not support a probe, i.e., where the CNC machines cannot detect the location of the CNC fixture or the blank stock within the CNC machine.

An example of a calibration part will now be discussed. The calibration part may include milled reference surfaces and unmilled areas in each of the x, y, and z axes. The calibration part may then be measured, and more specifically the reference surfaces may be measured relative to the unmilled surfaces.

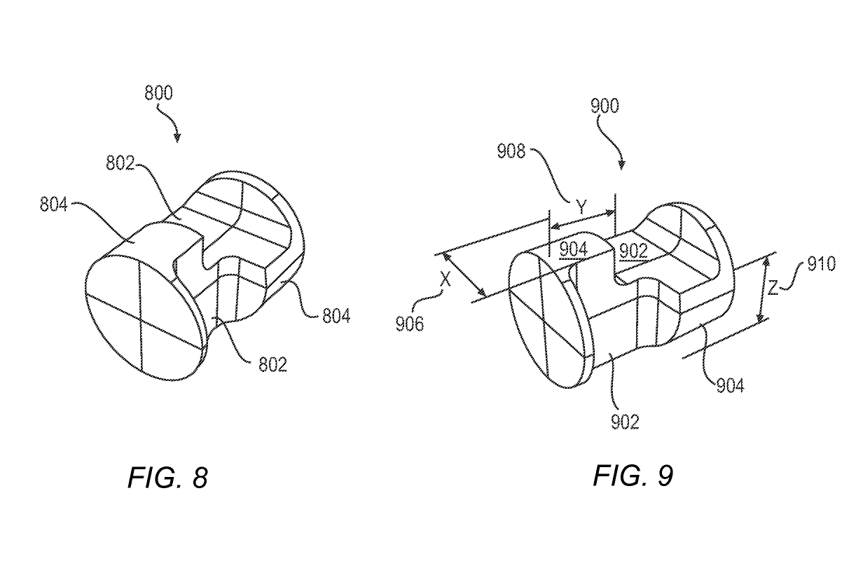

FIG. 8 is a front perspective view of a calibration part. The calibration part 800 may include milled reference surfaces 802, e.g., on the top and sides of the calibration part 800, and unmilled surfaces 804, which can also be disposed on the top and sides of the calibration part 800.

FIG. 9 is a side perspective view of a calibration part. Similar to the figure discussed above, the calibration part 900 may include milled reference surfaces 902 and unmilled surfaces 904. As shown in the figure, the milled reference surfaces 902 and unmilled surfaces 904 may include portions along each of the x-axis 906, y-axis 908, and z-axis 910.

After the calibration part 900 is created, the milled reference surfaces 902 may be measured as discussed above. In one aspect, after the calibration part 900 is measured, the measurements are used to determine how to shift an abutment geometry in the x-axis 906, y-axis 908, and z-axis 910 in order to align the abutment geometry with the CNC fixture that was used to create the calibration part 900. Predetermined coordinates may be used for this purpose.

The calibration parts discussed above may be created from a calibration blank.

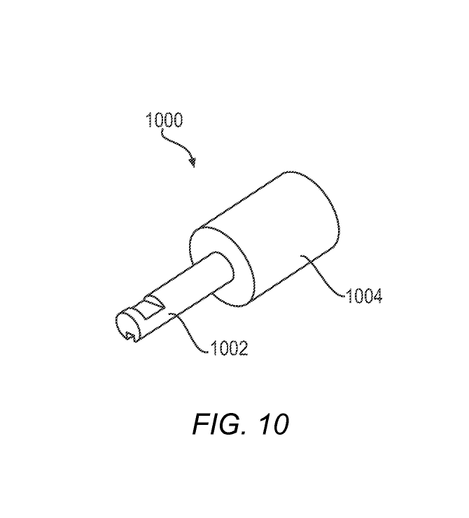

FIG. 10 is a side perspective view of a calibration blank. The calibration blank 1000 may include an existing pre-formed blank, or a blank manufactured specifically for the purpose of calibration. The calibration blank 1000 may include a first portion 1002 and a second portion 1004.

The first portion 1002 may be configured for engagement with a CNC fixture such that the calibration blank 1000 can be secured in the CNC fixture during a milling operation performed by a CNC machine or the like. The first portion 1002 may also or instead include a pre-formed interface as described herein, e.g., a manufacturer implant interface.

The second portion 1004 may be configured for milling, i.e., it is the portion of the calibration blank 1000 in which the reference surfaces will be milled into the calibration blank 1000. As shown in the figure, the second portion may include a substantially cylindrical-shaped stock. The second portion 1004 may instead include other shapes, such as being substantially block-shaped or the like.

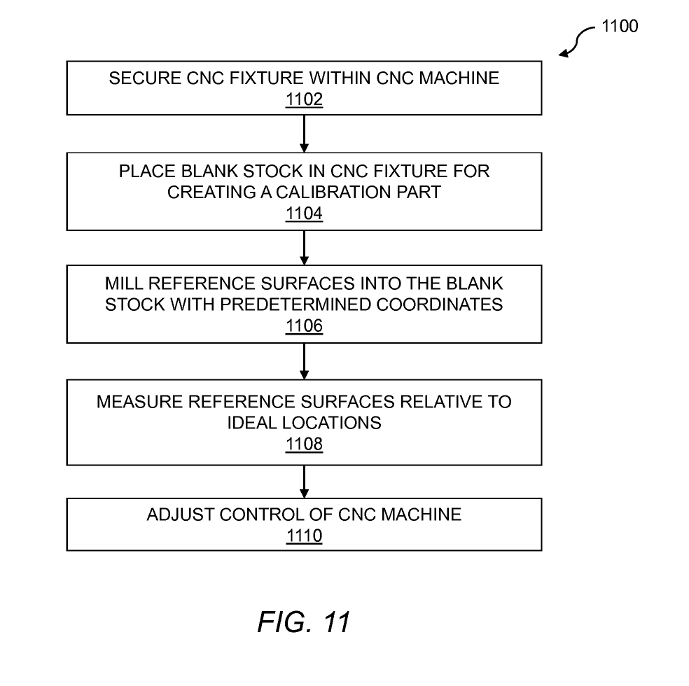

FIG. 11 is a flowchart showing a method for calibrating a CNC machine.

As shown in step 1102, the method 1100 may include securing a CNC fixture within a CNC machine. Securing the CNC fixture within the CNC machine may be accomplished by any means described herein or otherwise known in the art.

As shown in step 1104, the method 1100 may include placing a blank stock in the CNC fixture for creation of a calibration part by the CNC machine.

As shown in step 1106, the method 1100 may include milling a plurality of reference surfaces into the blank stock held by the CNC fixture. The plurality of reference surfaces may include surfaces corresponding to each of an x, y, and z axis. The plurality of reference surfaces may include predetermined coordinates, which may be measured relative to one or more of the CNC fixture, the CNC machine (or any component thereof), a portion of the blank stock, and so forth. The milling may include leaving unmilled areas of the calibration part.

As shown in step 1108, the method 1100 may include measuring the reference surfaces relative to ideal locations for the reference surfaces to determine a shift in each of the x, y, and z axes. The ideal locations for the reference surfaces may be predetermined, e.g., they may be formulated by CAD or CAM software. The shift may represent the difference between the predetermined ideal locations for the reference surfaces and their actual locations. The measurements may be relative to one or more of the predetermined coordinates, the CNC fixture, the CNC machine (or any component thereof), a portion of the calibration part, and so forth.

As shown in step 1110, the method 1100 may include adjusting a control of the CNC machine according to the shift to calibrate the CNC machine with the CNC fixture secured therein. The control may, for example, adjust the tooling of the CNC machine to account for the shift.

The techniques described herein may be implemented in a CAM setup that very closely matches the current state of the CNC machine and CNC fixture. The calibration processes described herein may be completed periodically (e.g., once a week, once a month, or whenever the CNC fixture is removed and reinserted into the CNC machine).

With regard to any positioning discussed herein, while an x, y, z coordinate system serves as a convenient basis for positioning within three dimensions, any other coordinate system or combination of coordinate systems may also or instead be employed, such as cylindrical or spherical coordinates. Similarly, where additional degrees of freedom might be usefully tracked using the calibration part as contemplated herein, a number of milled features with rotational orientations about each axis may also or instead be used.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

Embodiments disclosed herein may include computer program products comprising computer-executable code or computer-usable code that, when executing on one or more computing devices, performs any and/or all of the steps of the control systems described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method for calibrating a computer numerical control (CNC) machine comprising:
obtaining a design of an implant abutment having an implant interface, the implant abutment including an abutment geometry;
creating a calibration part for the CNC machine by milling a plurality of reference surfaces into a blank stock held by a CNC fixture, the plurality of reference surfaces including surfaces corresponding to each of an x, y, and z axis with predetermined coordinates, wherein the milling includes leaving unmilled areas of the calibration part;
measuring the plurality of reference surfaces relative to the unmilled areas of the calibration part;
determining a shift in the abutment geometry in each of the x, y, and z axes by comparing measurements obtained from the calibration part to the predetermined coordinates; and
adjusting a control of the CNC machine according to the shift in the abutment geometry to match a present state of the CNC machine and the CNC fixture.

2. The method of claim 1, wherein the blank stock includes the implant interface pre-formed thereon.

3. The method of claim 1, wherein the blank stock is manufactured specifically for calibration.

4. The method of claim 1, wherein adjusting the control of the CNC machine includes adjusting a setup of a computer-aided manufacturing (CAM) system.

5. The method of claim 1, wherein the implant abutment is a dental implant abutment, and wherein the implant interface is a dental implant interface pre-formed on a stock of material to be milled into the implant abutment, the dental implant interface configured to engage with a corresponding interface disposed on a dental implant.

6. The method of claim 1 further comprising milling a stock of material according to the design of the implant abutment using the CNC machine.

7. The method of claim 1, wherein the abutment geometry is customized for a patient's anatomy.

8. The method of claim 1, wherein positioning of the abutment geometry relative to the implant interface affects one or more of a function, a look, a feel, and an effectiveness of a dental implant when the dental implant is engaged with the implant abutment.

9. The method of claim 1, wherein the shift in the abutment geometry is relative to the implant interface.

10. The method of claim 1, wherein the shift includes at least one of an angular shift or a rotation.

11. The method of claim 1, wherein the shift in the abutment geometry is further determined from a comparison of expected measurements of the plurality of reference surfaces to actual measurements of the plurality of reference surfaces.

12. The method of claim 1 further comprising recording the shift using CAM software.

13. The method of claim 1 further comprising adjusting the abutment geometry to be milled into a stock of material for creating the abutment.

14. The method of claim 1 further comprising offsetting blank stocks in each of the x, y, and z axes based on the determined shift.

15. The method of claim 1, wherein the CNC fixture includes a tooling plate customized for creation of implant abutments.

16. The method of claim 1, wherein the implant interface includes a substantially hexagonal shape.

17. The method of claim 1, wherein the implant interface includes a void for accepting a projection from a dental implant.

18. The method of claim 1, wherein the design of the implant abutment is created using three-dimensional scanning.

19. The method of claim 1, wherein the CNC machine does not include a probe.

20. A method for calibrating a computer numerical control (CNC) machine comprising:
securing a CNC fixture within a CNC machine;
placing a blank stock in the CNC fixture for creation of a calibration part by the CNC machine;
milling a plurality of reference surfaces into the blank stock held by the CNC fixture, the plurality of reference surfaces including surfaces corresponding to each of an x, y, and z axis with predetermined coordinates, the milling including leaving unmilled areas of the calibration part;
measuring the reference surfaces relative to ideal locations for the reference surfaces to determine a shift in each of the x, y, and z axes; and
adjusting a control of the CNC machine according to the shift to calibrate the CNC machine with the CNC fixture secured therein.
